(19) United States
(12) Patent Application Publication
(10) Pub. No.: US 2006/0261045 A1
(43) Pub. Date: Nov. 23, 2006

(54) Multi-heat source laser brazing system and method

(76) Inventors: Pei-Chung Wang, Troy, MI (US); Michael Gerard Poss, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/131,533

(22) Filed: May 18, 2005

(51) Int. Cl. B23K 1/005

(52) U.S. Cl. 219/85.12; 219/121.85; 219/85.13

(57) ABSTRACT

An improved brazing system having a plurality of heat sources is adapted for brazing in tandem a plurality of adjacent workpieces and for reducing porosity in the braze joint. The system preferably includes a first laser beam that engages the workpieces to vaporize surface contaminants thereupon, a second laser beam configured to melt the brazing material, and a third laser beam configured to further heat the material, so as to extend the thermal cycle thereof or re-melt the material.

### BACKGROUND OF THE INVENTION

1. Field of the Invention

The present invention relates to joining systems, and more particularly to an improved system and method for laser brazing a plurality of workpieces.

2. Discussion of Prior Art

The process of material joining and treatment is a necessary condition for industrial progress and construction. One such process, commonly known as laser assisted brazing, has been developed to provide precise seam joints, and is commonly used, for example, in the automotive industry to join a plurality of workpieces. This technology utilizes a filler wire to provide the joint material and a conventional laser to melt the filler wire into the seam to be joined. The use of lasers as the source of heat energy enables more accurate application of energy, which thereby results in the advantage of less heat distortion being experienced by the workpieces, than does more traditional forms of brazing such as furnace brazing. Among other advantages, laser assisted brazing provides faster joining speeds, and produces a stronger weld than a traditional seam of resistance spot welds. As a result of lower melting temperatures and heats of fusion, laser brazing also utilizes less heat energy during joining, than does other conventional welding techniques.

Laser assisted brazing, however, also presents various concerns. While rapid cooling temperatures associated with laser brazing provides stronger joints, they also result in a loss of ductility in certain materials. The relatively short thermal cycle increases the likelihood of intergranular cracking and pore formation that degrade the surface appearance and functionality of the joint. These pores typically result when gaseous emissions from vaporized contaminants (e.g., lubricant) fail to escape the narrow braze during the process. The necessary treatment of these cracks and pores further realizes significant increases in costs associated with post-brazing finishing.

For these reasons in part, there results a need in the art for a more efficient brazing process that reduces the likelihood of construction inefficiencies, including porosity.

### BRIEF SUMMARY OF THE INVENTION

Responsive to these and other concerns caused by conventional laser brazing systems, the present invention provides an improved brazing system for decreasing the likelihood of construction inefficiencies, such as pore formation, within the braze joint. This invention is useful, among other things, for reducing the costs associated with inspection and treatment of braze joint porosity. For example, as a result of the inventive system and method, post-brazing finishing to remove pores in preparation of painting is minimized.

This invention provides a method of brazing workpieces utilizing multiple quantities of heat energy for in tandem joining. More particularly, a first aspect of the present invention concerns a system for joining a plurality of workpieces to form a braze joint, wherein said workpieces cooperatively present an exposed narrow groove. The system includes a fusible material positionable substantially adjacent the groove, and a plurality of heat energy sources. A portion of said plurality of sources is configured to melt at least a portion of the material into the groove, such that the molten material contacts, interconnects with and is retained by engaging surfaces defined by the workpieces. Finally, the sources are cooperatively configured to produce the joint.

A second aspect of the present invention concerns a method of joining a plurality of workpieces to form a braze joint. The workpieces cooperatively present an exposed narrow groove and adjacent joint engaging surfaces. A first quantity of heat energy is applied to at least a portion of the surfaces, so as to vaporize surface contaminants thereupon. A fusible material is secured in a position relative to the at least portion of the surfaces, such that the material flows into the groove and contacts the at least portion of the surfaces when melted. A second quantity of heat energy is applied to at least a portion of the material sufficient to melt the at least portion of material. A third quantity of heat energy is applied to the at least portion of material, so as to further heat and increase the thermal cycle of the at least portion of material or re-melt at least a portion of the metal.

Other aspects and useful advantages of the present invention will be apparent from the following detailed description of the preferred embodiment(s) and the accompanying drawing figures.

### BRIEF DESCRIPTION OF THE SEVERAL VIEWS OF THE DRAWING

A preferred embodiment of the invention is described in detail below with reference to the attached drawing figures, wherein:

FIG. 1 is a prospective view of a plurality of workpieces and a brazing system in accordance with a preferred embodiment of the present invention, particularly illustrating a three heat source system, wherein the optional nature of the first or third source (but not both) is shown in hidden line;

FIG. 2 is a top view of the workpieces and system shown in FIG. 1;

FIG. 3 is a cross-sectional view of the workpieces and system shown in FIGS. 1 and 2, taken along line A-A;

FIG. 4 is a cross-sectional elevation view of the workpieces and system shown in FIGS. 1 and 2, taken along line B-B;

FIG. 5a is a cross-sectional elevation view of a preferred embodiment of the system, particularly illustrating a three laser beam system, wherein the laser beams are split from an initial beam;

FIG. 5b is a cross-sectional elevation view of a preferred embodiment of the system, particularly illustrating a two laser beam and plasma-arc welder system, wherein the laser beams are split from an initial beam;

FIG. 5c is a cross-sectional elevation view of a preferred embodiment of the system, particularly illustrating a two laser beam and electrode system, wherein the laser beams are split from an initial beam;

FIG. 5d is a cross-sectional elevation view of a preferred embodiment of the system, particularly illustrating the first pass of a reciprocating or circulating heat source, and prospective second and third passes shown in hidden line;

FIG. 6a is a pedagogic diagram of a method sequence in accordance with a preferred embodiment of the present invention, particularly illustrating a three heat source system;

FIG. 6b is a pedagogic diagram of a method sequence in accordance with a preferred embodiment of the present invention, particularly illustrating a pre-melting heat source; and

FIG. 6c is a pedagogic diagram of a method sequence in accordance with a preferred embodiment of the present invention, particularly illustrating a post melting heat source.

### DETAILED DESCRIPTION OF THE INVENTION

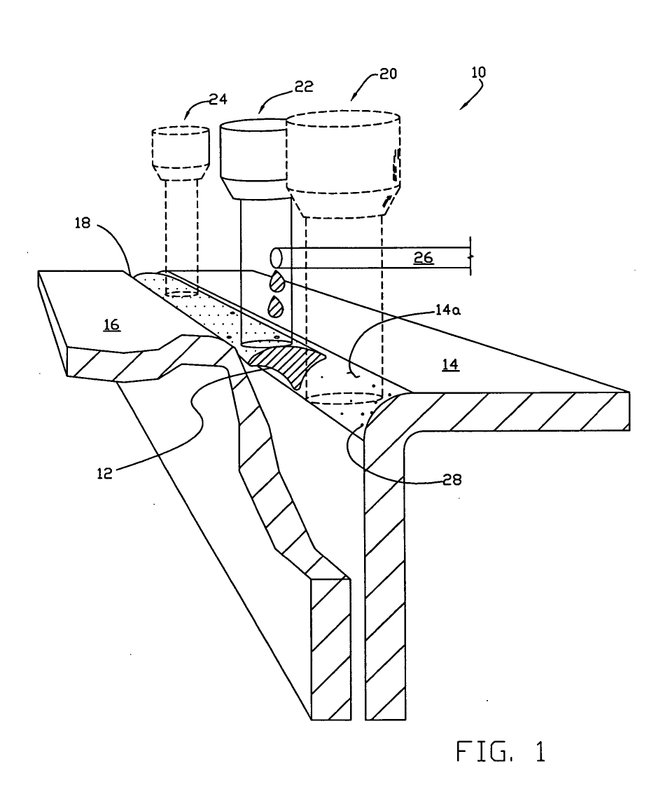

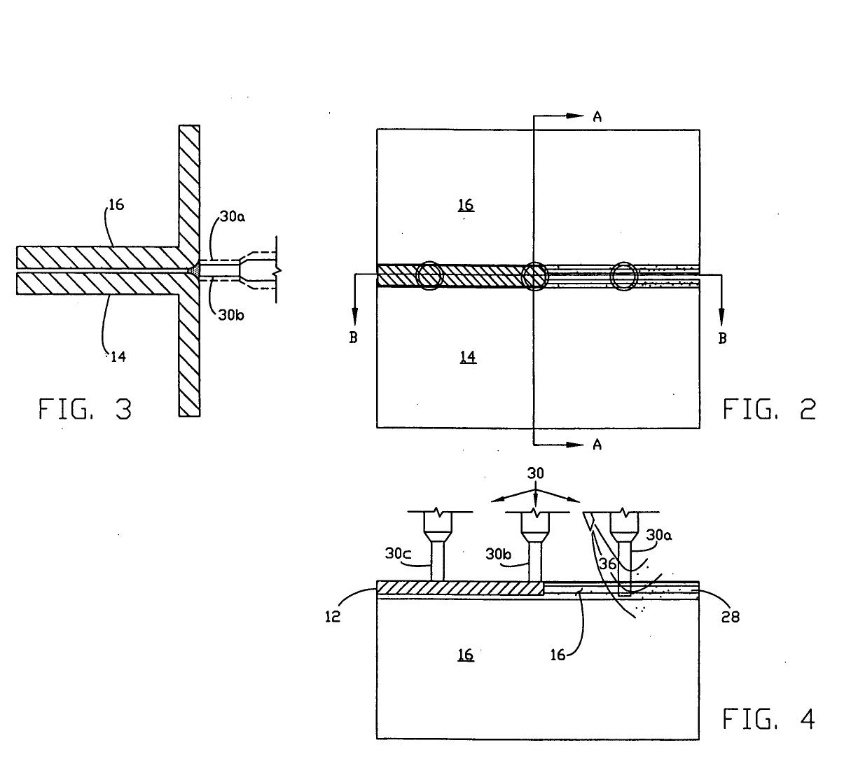

The present invention concerns an improved brazing system 10 for joining a plurality (i.e.; two or more) of adjacent workpieces, such as automotive sheet metal and engine cradle parts, to produce a braze joint 12. In the illustrated embodiments shown in FIGS. 1 through 3, a plurality of two workpieces 14,16 of equal thickness are shown; however, the system 10 may be utilized to join a greater plurality of structural components having variable thickness. The workpieces 14,16 are positioned so as to form a narrow exposed groove 18. The workpieces 14,16 may be formed of a wide range of materials including industrial steels, iron alloys, aluminum alloys, magnesium alloys, titanium and molybdenum. Although described herein with respect to a linear joint and flat metal, it is well within the ambit of the present invention for the system 10 to be used for the circular joining of tubular members or other complex configurations.

Turning to the configuration of the system 10 as shown in FIGS. 1 through 4, a plurality of three heat sources 20, 22, 24 are provided to cooperatively form braze joint 12. Fusible material 26, preferably in the form of spooled brazing wire, such as a 1.6 mm diameter Silicon Bronze wire, provides the filler material for the joint 12. As in conventional brazing, the heat source 22 is configured to melt at least a portion of the material 26 into the groove 18, so that the molten material contacts, interconnects with and is retained by joint engaging surfaces 14a,16a (see, FIGS. 1 and 4) defined by the workpieces 14,16. In the present invention, however, before the material is melted, the first heat source 20 is configured to engage the surfaces 14a, 16a with sufficient energy to ablate surface contaminants 28, such as lubricant or oxide, typically found thereupon in industrial applications. The third heat source 24 is configured to further heat the molten material 26, so as to extend the thermal cycle thereof. Finally, the heat sources 20-24 are preferably translatable relative to the workpieces 14,16 and may be manually controlled, or controlled by electro-mechanical means (not shown). More preferably, the system 10 is robotically controlled along multi-axes and is programmably adjustable.

It is appreciated that heating the surfaces 14a, 16a, and further heating the molten material 26 is useful, among other things, for reducing porosity within the joint 12. As previously mentioned, the first heat source 20 removes surface contaminants before the process, thereby resulting in fewer gaseous emissions during brazing. The third heat source 24 retards formation of the joint by increasing the temperature of the molten material. The longer molten period provides additional opportunity for the remaining gaseous emissions, resulting from non-ablated surface contaminants or wire-borne contaminants, to escape.

In the illustrated embodiments, at least a portion of the preferred heat sources 20-24 is produced by at least one laser 30. However, as shown in FIGS. 5b,c and discussed below, it is well within the ambit of the invention for other focused heat sources to be utilized, such as a suitable IR technology, and plasma or tungsten arc welders. It is appreciated by those ordinarily skilled in the art that the laser 30 provides precise and consistent conventional means for focusing heat energy as desired. In FIGS. 1 through 4, a plurality of three lasers 30 produce the three heat sources, i.e., laser beams 30a-c, individually. As a compartmentalized system it is further appreciated that individual repair and replacement of heat sources 20-24 and modifications of configuration based on a particular application are facilitated. Suitable lasers 30 to be used in the present invention include CO₂, fiber, or YAG lasers pumped using laser diodes or flash lamps. Each of the lasers 30 may also have individual or simultaneous processing capacity. Finally, each of the lasers 30 preferably produces a variable power output.

Where linear joining is desired, the three beams 30a-c preferably engage the surfaces 14a,16a and material 26 at points on a line oriented along the longitudinal axis of the soon to be formed joint 12. Irrespective of configuration, however, succeeding beams-need not be equally spaced. In FIG. 5a, a single laser 30 is configured to engage the surfaces 14a,16a and material 26 with three beams 30a-c. That is to say, the laser 30 produces an initial beam, which is optically split into three concurrent beams. Laser beam 30a is configured to engage the surfaces 14a,16a and ablate the surface contaminates 28, while the second and third beams 30b,c are configured to melt and further heat the material 26 as previously described.

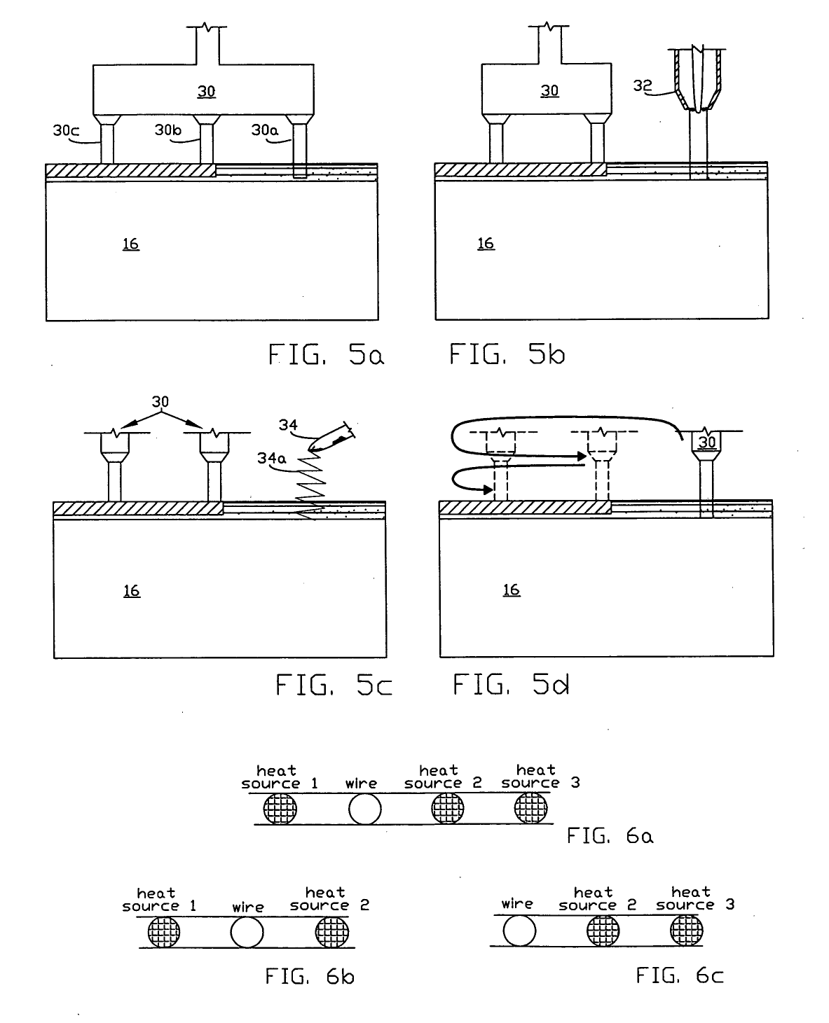

Thus, a preferred method of brazing is presented, wherein a first laser 30 is translated relative to a plurality of workpieces 14,16, so as to engage a beam 30a with surfaces 14a, 16a of the workpieces. Next, fusible material 26, i.e. wire, is positioned relative to a groove formed by the workpieces 14,16, such that the material 26, when molten, flows into contact with the surfaces 14a,16a and is retained intermediate the-workpieces. The molten material 26 contacts and interconnects with the surfaces 14a,16a. After the material 26 is melted into place, the third beam 30c engages the material 26 to further heat the molten pool, thereby extending the thermal cycle thereof. This three-source sequence is diagrammatically represented in FIG. 6a. Finally, after the heat source 24 is applied, the material pool 26 is cooled by the surrounding unheated workpieces and atmosphere to solidify and form the braze joint 12.

As shown in FIGS. 5b,c and previously mentioned, the preferred system 10 may alternatively include a plasma-arc welder 32 or an electrode 34 configured to form an electric arc 34a between the material 26 or surfaces 14a,16a. The heat generated by the arc 34a is sufficient to melt the material 26. A suitable process utilizes a non-consumable tungsten electrode to form the arc, and feeds gas (i.e., Argon, Argon/Helium, or Argon/Hydrogen combination) through a torch nozzle to shield the arc and material pool from outside reactants. As shown in FIG. 4, where used as the initial source 20 to ablate surface contaminants, it is further appreciated that a gaseous stream 36 (in combination with any heat source) serves to remove vaporized contaminants from the groove 18. Where used to heat the material 26, the electrode 34 may further present a fusible distal portion that melts during the process. In this configuration, the electrode 34 is positioned so that the drippings (not shown) fall into the molten material 26. A suitable process for use in this configuration is commonly known as Gas Metal Arc welding (GMAW).

Alternatively, the system 10 may be simplified by removing either the first or third heat source. For example, FIG. 6b shows a sequence wherein the third source is eliminated and porosity is reduced solely by ablating surface contaminants with the initial source. FIG. 6c diagrammatically represents a two-source sequence, wherein the first source is eliminated and porosity is reduced solely by increasing the thermal cycle of the molten pool. In another alternative, a single reciprocating or circulating device may be utilized to provide the three heat sources described herein, wherein each pass constitutes an individual heat source (see, FIG. 5d). While the first pass may treat the entire surfaces 14a, 16a, the second and third passes may be truncated in accordance with the rate of cooling of the brazing material.

Obvious modifications to the exemplary embodiments and methods of operation, as set forth herein, could be readily made by those skilled in the art without departing from the spirit of the present invention. The inventors hereby state their intent to rely on the Doctrine of Equivalents to determine and assess the reasonably fair scope of the present invention as pertains to any system not materially departing from but outside the literal scope of the invention as set forth in the following claims.

What is claimed is:

1. A system for joining a plurality of workpieces to form a braze joint, wherein said workpieces cooperatively present an exposed narrow groove, said system comprising:
a fusible material positionable substantially adjacent the groove; and
a plurality of heat energy sources, wherein a portion of said plurality of sources is configured to melt at least a portion of the material into the groove, such that the molten material contacts, interconnects with and is retained by engaging surfaces defined by the workpieces,
said sources being cooperatively configured to produce the joint, wherein the joint consists of the material.

2. The system as claimed in claim 1,
said sources including a first laser beam configured to melt said at least portion of the material.

3. The system as claimed in claim 2,
said laser beam being produced by a YAG, CO₂ or fiber laser.

4. The system as claimed in claim 1,
at least a portion of said sources being produced by a plasma or tungsten arc welder.

5. The system as claimed in claim 1,
at least a portion of said sources being configured to further heat the at least portion of material after the at least portion of material is melted, so as to extend the thermal cycle thereof.

6. The system as claimed in claim 1,
at least a portion of said sources being configured to engage said surfaces and vaporize surface contaminants thereupon, before said at least portion of material is melted.

7. The system as claimed in claim 6; and
a gaseous stream directed towards the surfaces, and configured to carry vaporized contaminants from the groove.

8. The claim as claimed in claim 7,
said stream consisting essentially of argon or nitrogen.

9. The claim as claimed in claim 1,
said sources including first and second laser beams.

10. The claim as claimed in claim 9,
said first and second laser beams being split from an initial laser beam.

11. The claim as claimed in claim 9,
said first and second laser beams being translatable, and configured to sequentially travel along a joint path, so as to form a continuous seam joint.

12. The claim as claimed in claim 9,
said sources including first, second and third laser beams.

13. The system as claimed in claim 1,
said plurality of sources being produced by a single reciprocating or circulating device.

14. The system as claimed in claim 1,
said material being selected from the group consisting essentially of steel, aluminum, aluminum alloy, magnesium alloys, copper, and copper alloys.

15. A system for joining a plurality of workpieces to form a braze joint, wherein said workpieces cooperatively present an exposed narrow groove, said system comprising:
a fusible material positionable substantially adjacent the groove; and
a plurality of heat energy sources cooperatively configured to produce the joint, including
a first source configured to melt at least a portion of the material into the groove, such that the molten material contacts, interconnects with and is retained by engaging surfaces defined by the workpieces,
a second source configured to engage said surfaces and vaporize surface contaminants thereupon, before said at least portion of material is melted, and
a third source configured to further heat the at least portion of material after the at least portion of material is melted, so as to extend the thermal cycle thereof.

16. A method of joining a plurality of workpieces to form a braze joint, wherein said workpieces cooperatively present an exposed narrow groove and adjacent joint engaging surfaces, said method comprising the steps of:
a. applying a first quantity of heat energy to at least a portion of the surfaces, so as to vaporize surface contaminants thereupon;
b. securing a fusible material in a position relative to the at least portion of the surfaces, such that the material flows into the groove and contacts the at least portion of the surfaces when melted;
c. applying a second quantity of heat energy to at least a portion of the material sufficient to melt the at least portion of material; and
d. applying a third quantity of heat energy to the at least portion of material, so as to further heat and increase the thermal cycle of the at least portion of material.

17. The method as claimed in claim 16, wherein separate heat energy sources are utilized to produce the first, second, and third quantities of heat energy.

18. The method as claimed in claim 16,
step (a) further including the steps of directing a laser beam against the at least portion of the surfaces.

19. The method as claimed in claim 16,
step (a) further including the steps of directing a gaseous stream towards the at least portion of the surfaces, so as to displace vaporized contaminants.

20. The method as claimed in claim 16,
steps (c) and (d) further including the steps of directing a laser beam against the at least portion of material.
